(19) United States
(12) Patent Application Publication
(10) Pub. No.: US 2017/0032435 A1
(43) Pub. Date: Feb. 2, 2017

(54) Swipe Shoppe

(71) Applicant: Francisco Severo Torres, Leominster, MA (US)

(72) Inventor: Francisco Severo Torres, Leominster, MA (US)

(21) Appl. No.: 15/069,897

(22) Filed: Mar. 14, 2016

(51) Int. Cl. G06Q 30/06; G06Q 50/00; G06Q 30/02

(52) U.S. Cl. CPC G06Q 30/0613; G06Q 30/0267; G06Q 30/0631; G06Q 30/0629; G06Q 30/0635; G06Q 50/01

(57) ABSTRACT

Swipe Shoppe connects the consumer with local deals wherever they are and connects them to the entire retail market and pre-owned items listed by private sellers in stores, at shops, and online. Combined with the retail and private sale markets online and physical store locations, “Swipe Shoppe” hopes to get the best product according to the exact prompt typed into the search bar, to the consumer at the faster than anything else, since “Swipe Shoppe” is the first and only product of its' kind. “Swipe Shoppe” will educate the consumer.

“Swipe Shoppe” is the future of shopping at the tip of your fingers. It takes the basic concept of “choice banking/saving” and makes shopping now fun and easy.

“Swipe Shoppe” simply opens as a program page with four options of the most recent product search. Simply place the name of anything your looking for the best price in the section labelled SB (FIG. 5, 10 FIG. 10, 8). SB stands for search bar. And result icons from anyone who lists their products on “SwipeShoppe” from any business on the internet, via private sale, snap and sell web platforms, such as gas, groceries, retail, and wholesale products, clothing, fast food, toys, yard supplies, home supplies ect. “SwipeShoppe” wants to provide a price and comparison format for every product that does not already have a platform to represent it. “SwipeShoppe” is like a site for everything else. “SwipeShoppe” is the future of shopping. The space labelled I in the drawings (See FIG. 1b, FIG. 2b, and FIG. 3b) is a space provided for the “SwipeShoppe” official business seal or icon. FIG. 5, 4 FIG. 10, 7 labeled are moving advertisement spaces. FIG. 1g, FIG. 2g, and FIG. 3g also labeled MAS are moving advertisement spaces as well. FIG. 1c, FIG. 2c, and FIG. 3c labeled MI is the space for the section “My SwipeShoppe” MI stands for My Icon (Icon standing for a seal or icon representation of “SwipeShoppe) The MI section brings a shopper to suggested products for their browsing pleasure. The MI section is a personal shopper type of software that learns the users' habits and preferences. FIG. 5, 4, FIG. 10, 7 (See drawings) labeled CB, is the “Choice Bar”. The CB is where a minimal amount of filter options will be listed in order keep “SwipeShoppe” simple. If you type in Jade Green box pleat skirt the

“SwipeShoppe” software and programs are going to sort through every product that matches the exact description and give it to you in an easy to use format. I want “SwipeShoppe” to be able to work on every type of system, tablet, computer, laptop, and smart phone that can run a mobile application, or website.

The buyer just needs to set up a basic profile (name and location, email, phone optional, and notification options)

“Swipe Shoppe” will also feature a direct message feature in which buyers and sellers can talk over deals (applicable to all business versions of “SwipeShoppe”. (This message section will be attached to the revolutionary “PreShopping Cart [will include the local retailer info as well as new comparable product availability, {this may be added at a later point but is part of the original development}]) “Swipe Shoppe” plans to have a messenger feature to connect customers and businesses for free. The thing that will make “Swipe Shoppe” an advertising wonder is because everyone wants used and pre owned products, but we sometime forget that we can acquire the newer version for a small addition to their possible investment on a pre-owned product. (As well as the product comparison section in the “Pre-Shopping Cart” [working with product review companies for exclusive contacting agreements {business to business}] Here is an example of how “Swipe Shoppe” works:

Barak is looking for a new TV and the Plasma and LEDs are becoming a thing of the past so he uses the “Swipe Shoppe” app he is going to find the product he wants at a quicker rate (because the mathematics and those on the team who work with mathematics are going to help me bring my idea to life [as well as the new products according to the ad package your local retailer purchases from “Swipe Shoppe”{unless it would be more prudent to make deals with the company heads themselves, but I am trying to help local economies, so this can be addressed at a later time}]) So Barak Knows that the “Swipe Shoppe” app in his state has been getting a lot of posts for the type of TV he wants 65 inch flat screen plasma or led, which he can put in on the first extension of the “buyers” section. The Advertising side of this app will simply place ads from whichever big companies buy space for a specified add. If Barak is looking for TVs the ad(s) will only be for TVs in his price range from local stores first, then to interne deals. So “Swipe Shoppe” is out here to help the people first, and the people's local retailers according to contracts deemed economically ethical. “Swipe Shoppe” is here to make shopping more fun and convenient, while also showing you the difference between buying new and used. Barak will see the personalized profile for each TV in his area pre-owned and new from all the stores who choose to run adds on “Swipe Shoppe” but it will only send Barak to his local retailers for anything. (“Swipe Shoppe” will also send alerts if a better price is listed or the product runs out or is sold, this can be done incrementally [the buyer and seller will have statuses to post such as negotiations, close to a deal, and sold {this will help the buyer know if they are about to lose their product etc., this also give more opportunity for advertising, locally and internationally, product dependent advertising and mathematics is the way of the future}])

The way “Swipe Shoppe” operates is on a one-page program format, with the top four options (product icons) of most specific to the word or phrase for the desired product typed in the search bar; products with different specifications and or prices and closest location are the result (See FIG. 5, 3 FIG. 10, 3). The product icon will be provided in the space marked PS (See FIG. 5, 3 FIG. 10, 3) As the user scrolls down with their fingers on a touch screen, mouse, or arrow keys, to the list the products will be listed farther from the subscriber. The price, and seller are the only things visible until the product icon is clicked, or the icon is swiped over to the section on the drawings labelled PSC (See FIG. 5, 7 FIG. 10, 11) PSC stands for Pre-Shopping Cart. The PSC is for future examination of desired of necessary products, when a product icon is swiped over to the PSC the next product icon takes the place after it, and so on until there are no more products. If Barak clicks or taps the product icon (Price, Product, Pictures, Distance from object for sale, and any personal contact information the seller/business wants to list) are brought up on a separate page with a more complete profile of the product. We can implement deals with product rating websites for an exclusive deal for product rating which will be accessible in the pre shopping cart. We do no shipping for anyone at “Swipe Shoppe” all we do is make shopping easier and fun for your local buyer and seller. I also predict that it will increase local retail revenue which will keep people searching for better deals using my app.

Future additions to “Swipe Shoppe” Will be plugins and other before and after thoughts such as:

Deals with major retailers on a local level giving rep jobs to people who work for “Swipe Shoppe” person to person (outside business contracts)

Deals with Apple and Android to push the app (Add space deals/agreements)

Ad specific gateway programming (this will make sure one looking for snow shoes does not get an ad for a boat company)

Expansion to outside your local market place (to other States [distance setter])

Product dependent advertising (goes along with what is mentioned above) if you are looking for kids' designer shoes you will get adds for mark downs on kids ibuprofen or a kids boutique with similar shoes [ads are few but will be mandatory possible short video or pop outs {costly ad space dependent on the products and companies in competition} that is that])

Simple advertising is what we are aiming for but we want all our ads to be specific to the product you are searching for. (The more “Swipe Shoppe” grows the more advertising room it will have for complex ads such as videos and pop out by clicking ads)

New products of the same caliber being searched for will be mixed in with used and preowned products and show up as one puts the items in the pre-shopping cart. (The local retailer may purchase add packages from our reps if I have the support to make it a more localized application)

“Swipe Shoppe's” pre shopping cart is revolutionary because it puts a different spin on how you look at the products you are going to purchase.

With the help of math and physics we will have the best summery and comparison page for any product you are looking for (linked to Google, Yahoo, Ask, Bing, or any other information site that will benefit the shopper using “Swipe Shoppe” [obviously dependent on what they want from “Swipe Shoppe” in return or for their services {I and “Swipe Shoppe” may need no affiliation with search engine companies, and go straight to retailers to save on costs}]) When one is ready to purchase a product found on “Swipe Shoppe” they will be prompted to the seller's website or store for purchase.

“Swipe Shoppe” is not responsible for any claims made by our users or advertisers, we are 100% disclosed about, and is not responsible for any fiscal losses made buy the buyer, seller or advertiser. We are simply a mobile application (as the brain child and 100% property of Francisco Severo Torres) that makes advertising better, improves the local economy, and helps the common man or wealthy business woman find the next product they are looking for within a lunch break (be it the cola sign from 1946, or that tiffany lamp, that she has been looking forward to furnishing the side table in the corner of her home office in her original wood floored penthouse) “Swipe Shoppe” makes all this possible from simple to complex, we make your next purchase where ever, or

[symbol]

### BACKGROUND OF THE INVENTION

“Swipe Shoppe” is an invention thought up by Francisco Severo Torres in the Fall (Spring) of the year 2013 in April. I was asking myself, “how can I make shopping more easy and fun for all shoppers?” I then came up with “Swipe Shoppe” the answer to all your shopping needs. “Swipe Shoppe” is intended to be made to connect, price, and compare products from private sale websites, up for auction websites, local businesses websites and stores, large wholesale and retail stores, specialty stores, restaurants, gas, and convince stores to insure a subscriber to “Swipe Shoppe” can be a more educated, time saving, and thrifty shopper.

### BRIEF SUMMARY OF THE INVENTION

“Swipe Shoppe” is a website and mobile application designed for all CPUs and Smart phone platforms. It will make searching for what you want to buy easier than ever before. It is a price and comparison invention to help expose consumers to more options in less time. “Swipe Shoppe” makes finding a product that you want immediately or in a couple of months as simple as it has ever been. Just search a product and find where it is at the best price. Or you can browse and discover new brands, vendors, and businesses you've never knew existed. “Swipe Shoppe” takes products from websites, stores, and all private sale sites and stores and brings them to the “Swipe Shoppe” platform. It makes browsing and pricing everything you shop for more simple. (All drawings were done with a WESTCOTT 12 inch ruler, and, an Artist's Loft 6 inch All Purpose Template for all the shapes in the drawings.)

### BRIEF DESCRIPTION OF THE SEVERAL VIEWS OF THE DRAWING

FIG. 1 The web browser view of a “Swipe Shoppe Loading” blueprint.

FIG. 1, 1 A blueprint view of a loading page made for web browsers.

FIG. 2. Skeleton web page blueprint.

FIG. 2, 1 Skeleton view of space to be shared by “miniature product profiles” a scroll bar, and a designated space for brand filters, and price filters [although the ultimate goal of the “Swipe Shoppe” Search Engine is to find a product only from typing exactly what the customer is looking for into the search bar, such as typing the price, product, brand, and any other specifics; ending up with the fastest way to plan and complete your shopping {that is, and always has been the ultimate goal}] earlier versions of “Swipe Shoppe” may need to include more filters in the designated filter section (product dependent) in that area.

FIG. 2, 2 View of designated space for perspective first draft of the graphic for the “My Swipe Shoppe” section. A personal shopping feature designed to learn how you shop, and on a separate page from the home page it will build pages of “Miniature Product Profiles” for you to browse or add to your “Pre-Shopping Cart” [space for the previously said {“Pre Shopping Cart”} section in relation to the view of this figure, is ((FIG. 2, 5))] it opens up endless options for product exposure and advertisement.

FIG. 2, 3 View of the space where the “Swipe Shoppe” [Company emblem or vowel and consonant lettering graphic] would he placed

FIG. 2, 4 View of space for Ads [possibly to correspond with ((FIG. 2, 7)) which is also ad space, and by correspond I mean possibilities of moving graphic Ads that advertise 1 product at a given moment for whatever time the advertiser from companies who what to advertise with “Swipe Shoppe” agree to in contracts.] terms of allocation and price on any ad space(s) have yet to be determined.

FIG. 2, 5 View of space for the “Pre-Shopping Cart” graphic.

FIG. 2, 6 View of space where a search bar would be located.

FIG. 2, 7 View of where more advertisement space will go.

FIG. 3 Skeleton layout of web browser [non-finalized graphics] with some filler.

FIG. 3, 1 View of a back drop on which the “Miniature Product Profiles” will be on top of.

FIG. 3, 2 View of the estimated amount of space to make the “Miniature Product Profile” look presentable [this is space for the first stage or view the customer will see {no actual graphic shown is a final design they should be seen as a blueprint to comprehend the nature of my invention}] this first view along with several other views/stages, intended to make any shopping experience faster and the overall sale of products more successful.

FIG. 3, 3 View of a graphic for the “My Swipe Shoppe” button [non-finalized graphic].

FIG. 3, 4 View of a graphic for the “Swipe Shoppe” name [non-finalized graphic].

FIG. 3, 5 View of graphic reading “Ad Space” a graphic that doubles as an indication of that denoted area being specifically for advertisement.

FIG. 3, 6 View of a non-finalized graphic for the “Pre-Shopping Cart” button in the right place [it will also double as the place the customer will click and drag, or swipe over the “miniature product profiles” to {hence the name “Swipe Shoppe”} where if they click the button it will have the product profiles on separate shopping lists based on product type, lists based on wants and needs, and things you might want to remind yourself to buy in the future, but mostly just so you can view it later on a separate part of the website so it won't even feel like it's in your shopping cart, it's a guilt free pre-shop.

FIG. 3, 7 View of where the space bar would go on this part of the blue print.

FIG. 3, 8 View of space where people can advertise.

FIG. 3, 9 View of space where a scroll bar would be located [final location of scroll bar has yet to be determined].

FIG. 3, 10 View of a section for search filters [every drawing is just a blueprint of different views of how “Swipe Shoppe” will work and a possible outline of a final design by a team of engineers and artists].

FIG. 4 Skeleton blueprint view of web browser format of “Swipe Shoppe” with a view of a [non-final] “Miniature Product Profile” in stage one.

(FIG. 4, 1 View of backdrop space.

FIG. 4, 2 View of stage one of a product profile view, including a picture[brand], store, location [distance], and price, I am going for whatever looks best for the final design of this.

FIG. 4, 3 View of section for [non-final] “My Swipe Shoppe” graphic.

FIG. 4, 4 View of “Swipe Shoppe” emblem or graphic section.

FIG. 4, 5 View of advertisement space.

FIG. 4, 6 View of “Pre-Shopping Cart” graphic and space.

FIG. 4. 7 View of search bar space.

FIG. 4, 8 View of advertisement space.

FIG. 4, 9 View of space for a scroll bar.

FIG. 4, 10 View of space for product filters.

FIG. 5 Blueprint of “Swipe Shoppe” homepage or post search with an arrow ((FIG. 5,2)) to denote a mouse curser click or finger pressure on a “miniature product profile” ((FIG. 5,3)) with intentions to swipe it over to the “Pre Shopping Cart” for future viewing.

FIG. 5, 1 View of backdrop space for the product profiles to be on.

FIG. 5, 2 View of an arrow with the intention to demonstrate a click or pressure [touch screen] to show that the “mini product profiles” can be moved to the “Pre-Shopping Cart”.

FIG. 5, 3 View of a blank “miniature product profile” being selected [when this is done {one click} a larger profile will be shown of the product on the same page, if the person only is using “Swipe Shoppe” for a quick shop on a desired product and it happens to be one that they will purchase online after finding it on “Swipe Shoppe” there will be a link in this second view {{of one click}} to the checkout section of that businesses website].

FIG. 5, 4 View of where the “My Swipe Shoppe” section will go.

FIG. 5, 5 View of where the “Swipe Shoppe” graphic or logo will appear.

FIG. 5, 6 View of advertisement space.

FIG. 5, 7 View of space for the “Pre Shopping Cart”.

FIG. 5, 8 View of space for a search bar.

FIG. 5, 9 View of an advertisement section.

FIG. 5, 10 View of an example of a design of the actual search bar [non-final].

FIG. 5, 11 View of space for a scroll bar.

FIG. 5, 12 View of section for product filters.

FIG. 6 View of an example of a “miniature product profile” [stage 2 view {1 click or with pressure applied [[touch screen devices]]} a horizontal view.

FIG. 6, 1 View of space for product pictures in the “miniature product profile” [stage 2 view].

FIG. 6, 2 View of backdrop space on a “miniature product profile” [to be color matched and compliment whatever product is being searched via agreements between companies and “Swipe Shoppe”].

FIG. 6, 3 View of an arrow representing the one click or tap on a touch screen device to bring the product from stage one to stage two, a semi larger view of a product's “miniature product profile”.

FIG. 6, 4 View of space designated for the store or seller of a product and the distance the product is away from you [all graphics vowels and consonants and any other writing in these drawings are intended to give a better understanding of how “Swipe Shoppe” will be finalized, these drawings are blueprints].

FIG. 6, 5 View of a section designated for the brand of a product searched for on a “miniature product profile [stage two].

FIG. 6, 6 View of a Section where the price of the product searched for would be listed.

FIG. 6, 7 View of Space for special product information and sales space.

FIG. 6, 8 View of Space for special product information and sales space.

FIG. 6, 9 View of Space for special product information and sales space.

FIG. 7 A blueprint horizontal view of a “miniature product profile” to show a different view of [stage two] of a “miniature product profile”.

FIG. 7, 1 View of backdrop space on a “miniature product profile” [to be color matched and compliment whatever product is being searched via agreements between companies and “Swipe Shoppe”].

FIG. 7, 2 View of an arrow representing the one click or tap on a touch screen device to bring the product from stage one to stage two, a semi larger view of a product's “miniature product profile”.

FIG. 7, 3 View of Space for special product information and sales space.

FIG. 7, 4 View of Space for special product information and sales space.

FIG. 7,5 View of Space for special product information and sales space.

FIG. 7, 6 View of a Section where the price of the product searched for would be listed.

FIG. 7, 7 View of a section designated for the brand of a product searched for on a “miniature product profile [stage two].

FIG. 7, 8 View of space designated for the store or seller of a product and the distance the product is away from you [all graphics vowels and consonants and any other writing in these drawings are intended to give a better understanding of how “Swipe Shoppe” will be finalized, these drawings are blueprints].

FIG. 7, 9 View of space for product pictures in the “miniature product profile” [stage 2 view].

FIG. 8 View of alternate links to gain more information about “Swipe Shoppe” on a skeleton blueprint of the web page [this section would be located at the bottom section of every page {with the exception of the settings page}]. (FIG. 8, 1 View of the word “Privacy” which represents the link to “Swipe Shoppe's” Privacy link/section/page.

FIG. 8, 2 View of the word “Webmasters” which represents a link to the page for information about the webmasters.

FIG. 8, 3 View of the word “About” that represents the link to the about page for “Swipe Shoppe”

FIG. 8, 4 View of the word “Contact” which represents a link to the contact information for “Swipe Shoppe”.

FIG. 8, 5 View of the word “Settings” which represents a link to the settings page for the “Swipe Shoppe” web browser version.

FIG. 8, 6 View of the word “Terms” which represents the link to the terms and conditions page of the website.

FIG. 8, 7 View of the word “Policy” which represents a link to the policies page of the website.

FIG. 8, 8 View of the word “Security” which brings the user to security section of the website.

FIG. 9 View of “Swipe Shoppe Loading” page for smart phones, tablets, and all compatible mobile devices.

FIG. 9, 1 View of a loading page for “Swipe Shoppe” the mobile application.

FIG. 10 View of a blueprint for the page layout of the “Swipe Shoppe” mobile application.

FIG. 10, 1 View of the words “company info” which represents a link to all of the links mentioned in (sec FIG. 8)

FIG. 10, 2 View of space with words in a circle representing possible moving graphic advertisement space [bottom left hand corner].

FIG. 10, 3 View of a rectangle marked “Pps” which, along with all other rectangles on that page represent the “miniature product profiles” on this application format blueprint version.

FIG. 10, 4 View of a rectangle marked “Ad. S” along with all the other rectangles with the same markings represent possible advertisement space [product search dependent on terms and conditions].

FIG. 10, 5 View of a click to delete ad space which would be replaced by a product for any product search on “Swipe Shoppe”.

FIG. 10, 6 View of space for a “Swipe Shoppe” company logo or graphic lettering.

FIG. 10, 7 View of the space for the “My Swipe Shoppe” button/link.

FIG. 10, 8 View of search bar space on this blueprint format.

FIG. 10, 9 View of space for the price and distance filters [drop down menu].

FIG. 10, 10 View of space for the brand and store [seller/business {drop down menu}].

FIG. 10, 11 View of space for the “pre-shopping cart” button.

FIG. 10, 12 View of space for a moving advertisement graphic.

FIG. 10, 13 View of the word settings that represents a link to settings section of the mobile application.

### DETAILED DESCRIPTION OF THE INVENTION

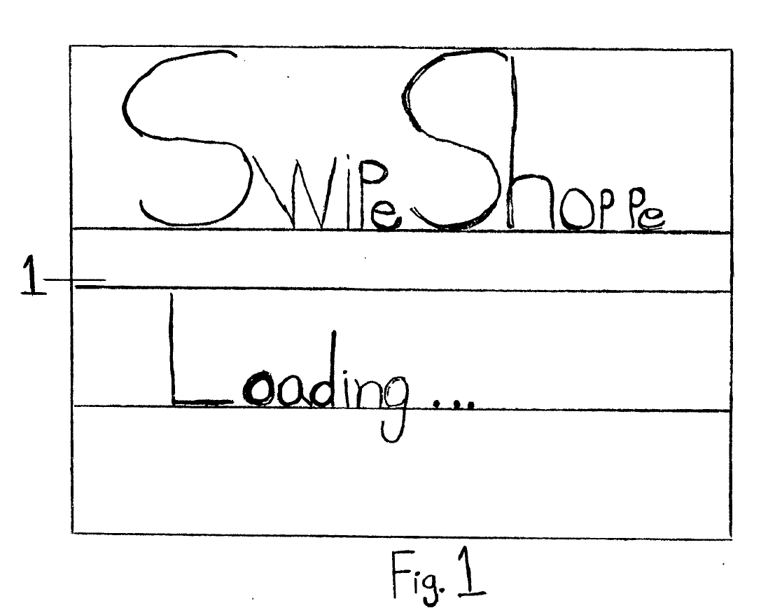

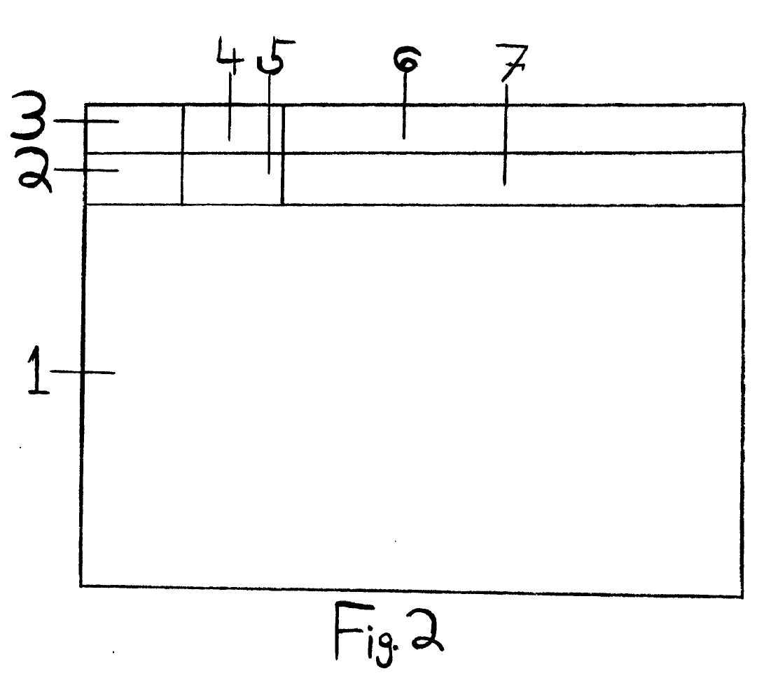

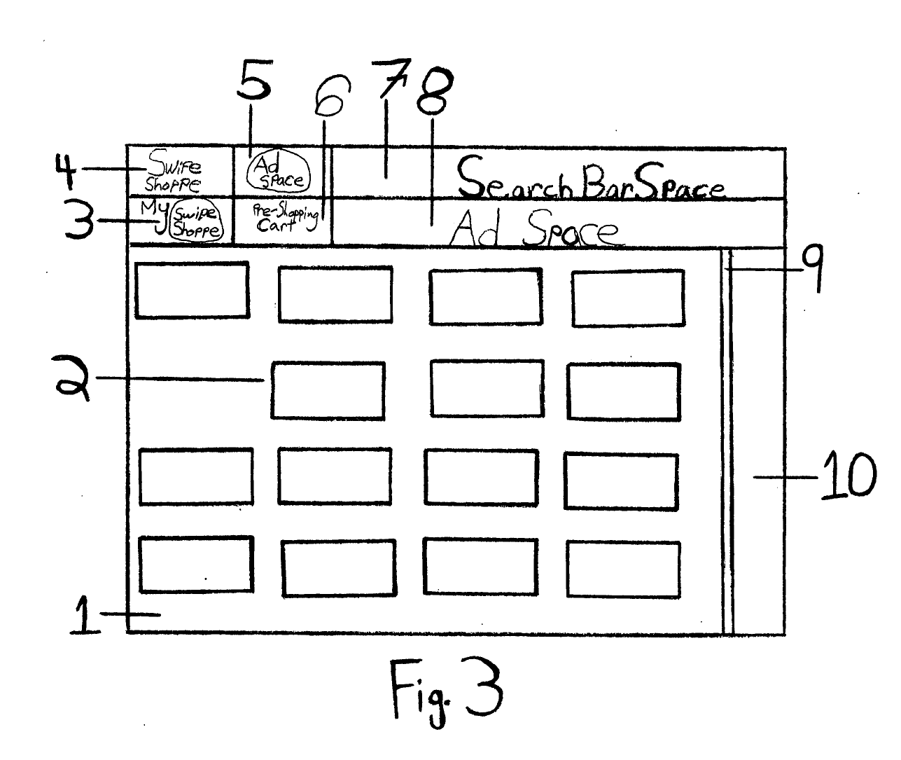

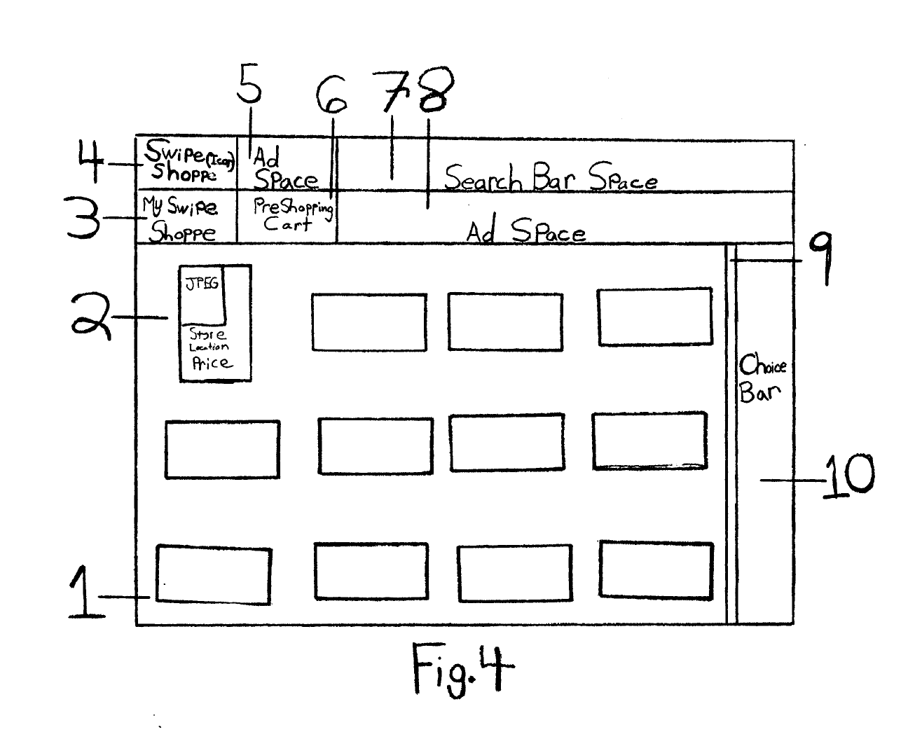

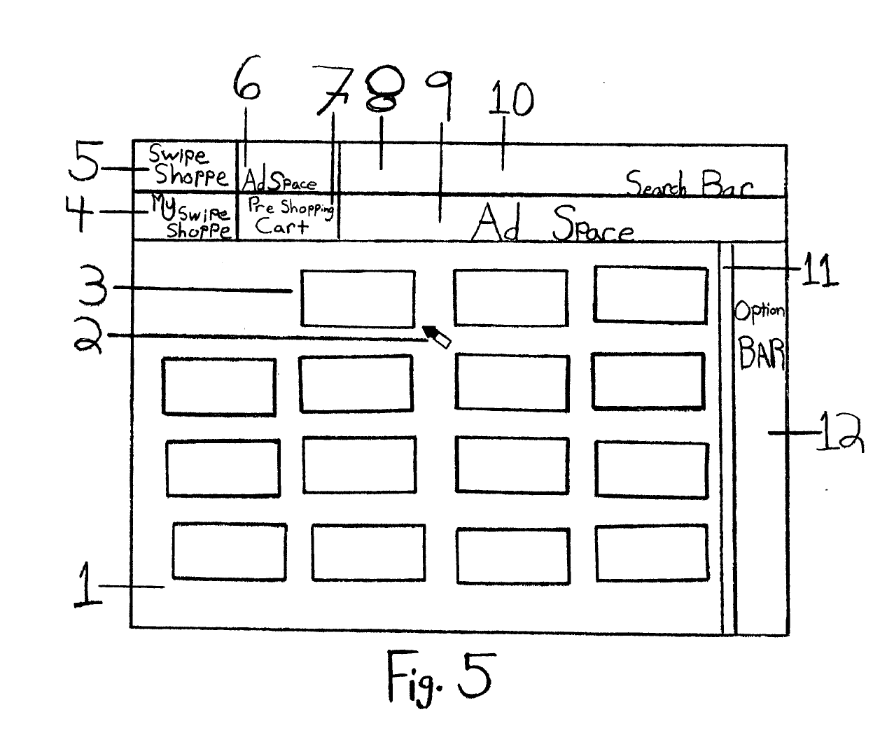

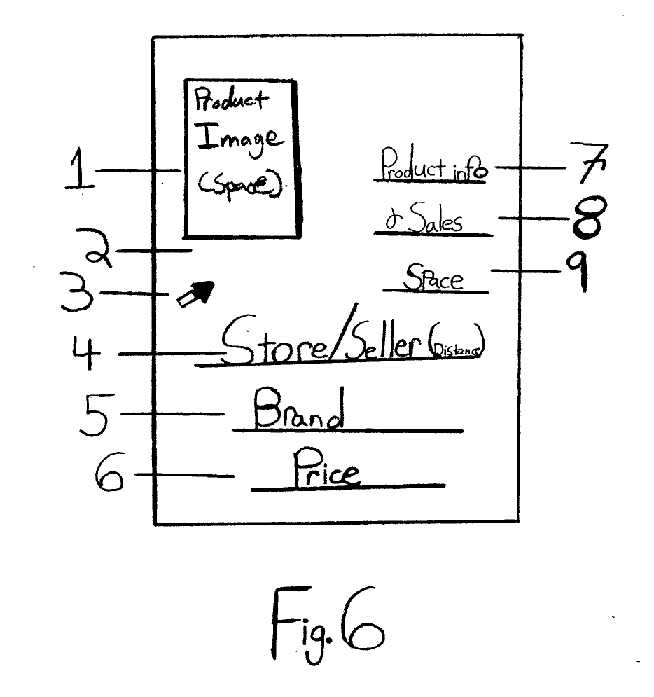

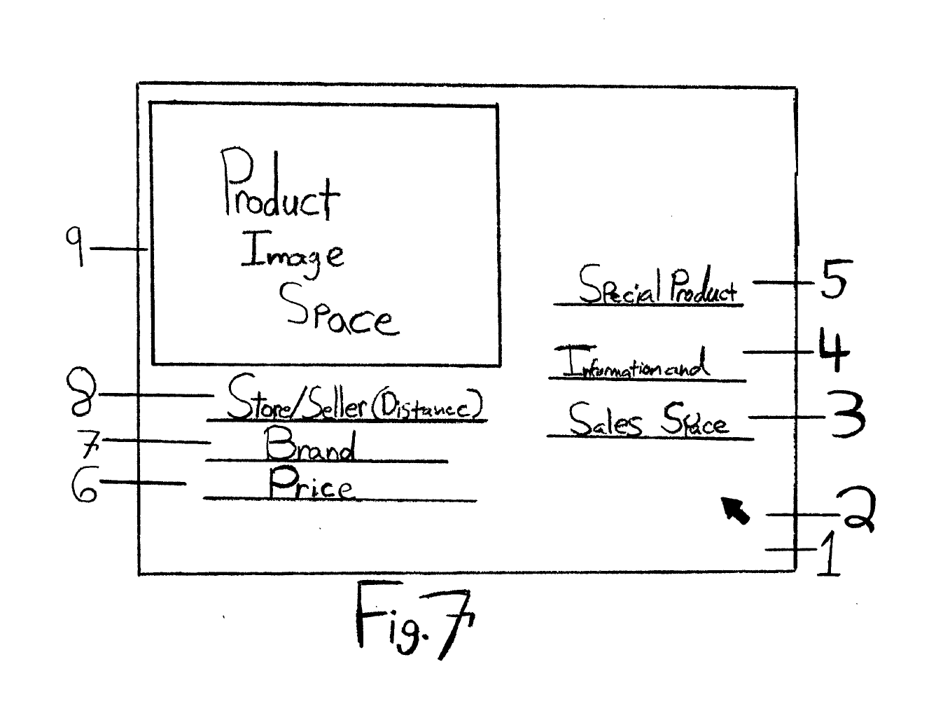

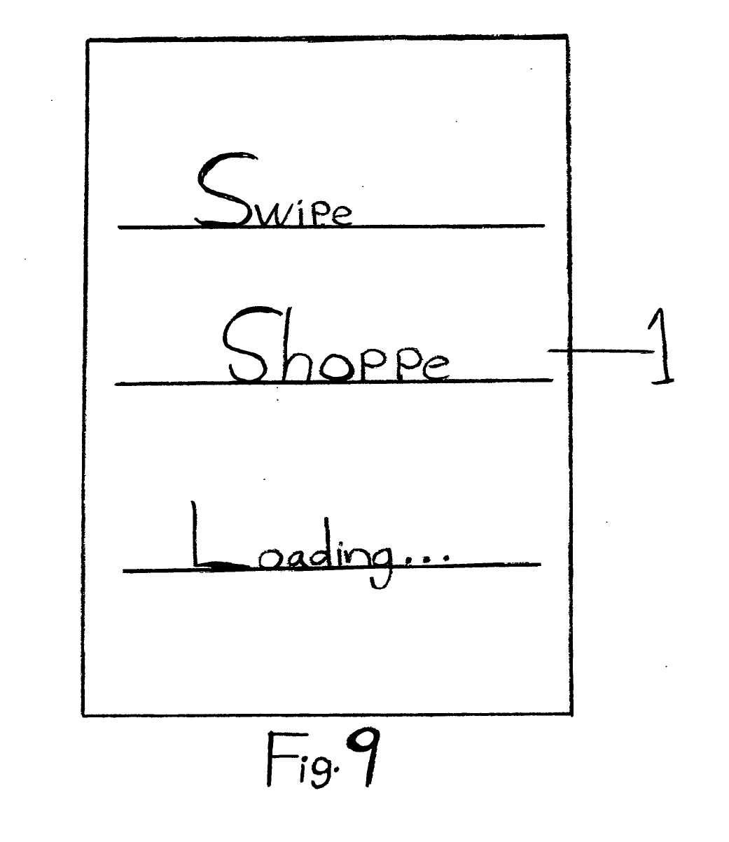

“Swipe Shoppe” simply opens as a program page with four options of the most recent product search once the mobile application is downloaded or the website is accessed. The buyer just needs to set up a basic profile from here (name and location, email, phone optional, and notification options) as well as billing information, since this is a subscription based service. The price to subscribe to “Swipe Shoppe” has yet to be determined. Just simply place the name of anything your looking for the best price in the section labelled “SB” (FIG. 5, 10, FIG. 10, 8). “SB” stands for search bar. The space labelled “Swipe Shoppe” in the drawings (See FIG. 5,5, FIG. 10, 6) is a space provided for the “Swipe Shoppe” official business seal or icon. FIG. 1d, FIG. 2d, and FIG. 3d labeled “MAS” are moving advertisement spaces. FIG. 1g, FIG. 2g, and FIG. 3g also labeled “MAS” are moving advertisement spaces as well. FIG. 1c, FIG. 2c, and FIG. 3c labeled “MI” is the space for the section “My Swipe Shoppe” “MI” stands for My Icon (Icon standing for a seal or icon representation of “Swipe Shoppe) The “MI” section brings a shopper to suggested products for their browsing pleasure. The MI section is a personal shopper type of software that learns the users' habits and preferences. FIG. 5, 12, FIG. 10, 9, and FIG. 10, 10 (See drawings) labeled is where a minimal amount of filter options will be listed in order keep “Swipe Shoppe” simple. If you type in Jade Green box pleat skirt the “Swipe Shoppe” software and programs are going to sort through every product that matches the exact description and give it to you in an easy to use format. I want “Swipe Shoppe” to be able to work on every type of system, tablet, computer, laptop, and smart phone that can run a mobile application, or website. “Swipe Shoppe” will also feature a direct message feature in which buyers and sellers can talk over deals (applicable to all business versions of “Swipe Shoppe”. (This message section will be attached to the revolutionary “Pre-Shopping Cart” ((FIG. 5, 7, FIG. 10, 11)) [will include the local retailer info as well as new comparable product availability, {this may be added at a later point but is part of the original development}]) “Swipe Shoppe” plans to have a messenger feature to connect customers and businesses for free. The thing that will make “Swipe Shoppe” an advertising wonder is because everyone wants used and pre owned products, but we sometime forget that we can acquire the newer version for a small addition to their possible investment on a pre-owned product. (As well as the product comparison section in the “Pre-Shopping Cart” [working with product review companies for exclusive contacting agreements {business to business}] The way “Swipe Shoppe” operates is on a one-page program format, with the top options ((miniature product profiles)) of most specific to the word or phrase for the desired product typed in the search bar; products with different specifications and or prices and closest location are the result ((FIG. 5, 3, FIG. 10, 3)). The product icon will be provided in the space marked ((FIG. 5, 3, FIG. 10, 3)) As the user scrolls down with their fingers on a touch screen, mouse, or arrow keys ((FIG. 5, 11)) the list the products will be listed farther from the subscriber. The price, and seller are the only things visible until the product icon is clicked, or the icon is swiped over to the section on the drawings labelled ((FIG. 5, 7, FIG. 10, 11)) PSC stands for Pre-Shopping Cart. The PSC is for future examination of desired or necessary products, when a product icon is swiped over to the PSC the next product icon takes the place after it, and so on until there are no more products. If Barak clicks or taps the product icon (Price, Product, Pictures, Distance from object for sale, and any personal contact information the seller/business wants to list) are brought up on a separate page with a more complete profile of the product. We can implement deals with product rating websites for an exclusive deal for product rating which will be accessible in the pre shopping cart. We do no shipping for anyone at “Swipe Shoppe” all we do is make shopping easier and fun for your local buyer and seller. I also predict that it will increase local retail revenue which will keep people searching for better deals using my app. “Swipe Shoppe” will have a sign in page where subscribers can sign in. “Swipe Shoppe” will have a sign up page where the consumer can sign up for the service by providing their information (Name, Location, Email, Password) “Swipe Shoppe” will use technology to bring every listed product on the interne or in stores and private sale to the “Swipe Shoppe” platform. Sellers will connect their product inventories to the “Swipe Shoppe” software for the staff to manage and reformat for “Swipe Shoppe” platform. The “Swipe Shoppe” software will know if the product being sought is available or not, and arrange the choices according to the seller's purchased “Product Space”.

Concerning the “Swipe Shoppe” business software, “Swipe Shoppe” application and website software, “Swipe Shoppe” business hardware, and “Swipe Shoppe's” server and cloud computing usage and workings:

The “Swipe Shoppe” business software is a simple program that takes products off of your companies' websites and converts products for redisplay to the “Swipe Shoppe” website and or tablet/mobile application software format. The products searched for will be converted to the “Swipe Shoppe” format, on the “Swipe Shoppe” home page the product space “PS” will be filled in blocks of four where they can be clicked on (website) or tapped (mobile application) for a converted mini-profile of the product, from here the subscriber can click to purchase that product, where they will be redirected to your companies' website or order page. The subscriber can scroll down to view more options as needed. From here they can click and drag their options to the “PSC” for later viewing. The software Purchase or lease of such software would be contractual, and have the open option of contracts with single or multiple entities, depending on the size of the business or corporation. When the buyer is ready to purchase a product, the link to: your small business websites, or large retail and wholesale websites and mobile applications, the link goes to the checkout or place order section on your companies' websites, this is where one will check out and proceed to pay (Application and website software). Since the “Swipe Shoppe” software is so revolutionary there would be no need to go to the options page on the next product you were going to purchase because if you type “skinny gold corduroy capris size 4” those are the options which appear in section marked ((FIG. 5, 3. FIG. 10, 3)) Meaning that if are 240 stores with that exact option listed with the use of the “Swipe Shoppe” business software only those options will be loaded for a quick checkout from my invention to your companies' websites or mobile applications. The section marked ((See FIG. 5, 12 FIG. 10, 9, FIG. 10, 10)) is where one will narrow down their search with price listing (low to high/high to low) and a distance bar to set how far away (in miles/kilometers) one would like to search for a particular product., and a check box to include web products and one to indicate actual stores. “Swipe Shoppe” knows the subscriber's location and keeps it private to make shopping more quick, simple and secure. If a company wished to prompt customers to continue to shop on their website “Swipe Shoppe” business software has nothing to do with the process on your businesses' websites. “Swipe Shoppe” business software will also connect to all of your customers' shopping profiles (if they chose that option [“Swipe Shoppe” application and website software]), if there is secure information on a profile than the “Swipe Shoppe” business software will protect it, and also provide a redirection link to tie in with those who have a profile with your businesses' website or application sign in page who may have security concerns, or are not frequent shoppers. If a shopper wants to connect all their favorite places to shop the “Swipe Shoppe” software will provide that option under ((FIG. 5, 4, FIG. 10, 7)) the “My Swipe Shoppe” section. This section will allow the user's profile on the “Swipe Shoppe” application and website to connect to all your shopping profiles for all your favorite stores so that the shopper can proceed immediately to check out. This prompt will come up in the initial download of the application after creating a “Swipe Shoppe” profile, and this connection can be applied to however many stores that you shop that are on the “Swipe Shoppe” software. The shopper would be able to add all stores, or be provided with a list of all the stores that they have a shopping profile on, to select from. The “My Swipe Shoppe” section will be an extension of the “Swipe Shoppe” application and website software. In the “My Swipe Shoppe” section a profile user can browse products prompted by companies' claims to that space. Meaning the products shown will be suggestions based on what the shoppers buy/might buy based on their buying habits (done with a simple calculation of the “Swipe Shoppe” mobile application and website software) and updates with every product searched and product purchased. The “Pre-Shopping Cart” “PSC” ((FIG. 5, 7, FIG. 10, 11)) is a place to save products you search for later viewing. If one were to “pre-shop” to price their groceries the “pre shopping cart” would act as a shopping list. So for example, if you find a better price or availability on any number of products you need at a different store from where you usually shop the “Swipe Shoppe” mobile application and website software will allow you to click and drag or hold and swipe it over to the “PSC”. Once there the “pre shopping cart” will remind you when you go grocery shopping that you have 3 products pick up in another store. The “Swipe Shoppe” mobile application and website software will record all of your online purchases and save them for future purchase with the “My Swipe Shoppe” section. It will also save your purchases from actual stores and businesses through a code, or scan application to reference your receipt (“Swipe Shoppe” business software) This is how all of your shopping trends and yearly spending can be tracked so that “Swipe Shoppe” can always make the right suggestions in the “My Swipe Shoppe” section. If one pays with a credit application or card the information will be relayed between the business and user software securely to avoid scanning the code. Shoppers who use the “Swipe Shoppe” mobile application and website to “pre-shop” can be influenced on the home page with deals on types of products that they would purchase from suggested stores, and stores they usually frequent. When they sign in (the app and site opens with a personalized page [a.k.a. “My Swipe Shoppe”] for registered users). But when it comes to a specific product search only that product would appear (pop up advertisement optional would on every page) and the section on the drawings marked “MAS” (Moving advertisement space [((See FIG. 5, 6 FIG. 5, 9, FIG. 10, 2, FIG. 10, 4, FIG. 10, 5, FIG. 10, 12))] would change dependent on advertisement purchase, but would be product dependent. Meaning if one were to search for baking goods only ads for that subject matter would apply. Depending on trends and profitability, the advertisement spaces should only be most relatable to the subscriber's search or products that are most relatable to the user (an individual's profile's advertisement space will update constantly between the business software and application and website software to insure optimal brand exposure) “Swipe Shoppe” will be a subscription based mobile application and website (at which time a price has not been determined) the price for a subscription/purchase/lease of the “Swipe Shoppe” business software is to be determined as well. I want all the “Swipe Shoppe” software and hardware to be cross compatible with all programming languages, and hardware systems to insure maximum exposure and profitability. The “Swipe Shoppe” hardware will be provided to any business on the “Swipe Shoppe” business software. It will act an independent server where the businesses' inventories can be secured for the website and mobile application. This hardware will also act as a type of server for storage of product profiles and information for that specific business location. The “Swipe Shoppe” software will be able to support a subscriber's small business website inventory only to a certain point before they would have to purchase the “Swipe Shoppe” business software. The “Swipe Shoppe” hardware will differ from store to store depending on computer brands and business size. The “Swipe Shoppe” hardware will be available for a business depending on ram and storage requirements of any particular store. It will provide your business with another way to store inventory and also help loss prevention. The “Swipe Shoppe” hardware and business software will be made to work with your location's current inventory software. The “Swipe Shoppe” hardware works with the business software to support your store's inventory that is listed on the “Swipe Shoppe” mobile application and website for consumers to see. The “Swipe Shoppe” business software basically makes shopping for the actual physical inventory of your local store(s) concrete to the shopper logged in to their profile. And it insures that once a product is sold out that a “Swipe Shoppe” subscriber will be the first to know. If you are a “Swipe Shoppe” subscriber and you have swiped a pint of blueberries over to the “Pre-Shopping Cart” from your favorite grocery store because you searched for a pint of blueberries in the search bar, but there happen to be 5 grocery stores within a 15 mile radius of your location if the one with the lowest price or farm that you like to buy from and previously swiped over happens to sell out through communication between the “Swipe Shoppe” software and business software and hard ware the closest price and product type availability will be suggested. This is applicable to anything swiped over to the “PSC”. If the product you want sells out the options are reconfigured for the subscriber. Larger hardware will be provided for every larger business main website server Headquarters for application operation support. There has been no price determined for any hardware or software construction or operation fees, whether purchase or lease. If one would like to link a personal selling profile “private sale” to be featured on the “Swipe Shoppe” mobile application and website search there will be a link for private seller's product they have for sale on (a snap and sell app. i.e. Wallapop, Let Go, etc.) or an auction site like (EBay) one can subscribe to “Swipe Shoppe” and the invention will give advertisement pricing to feature the product you are trying to sell, the “Swipe Shoppe” software will work with such websites and web companies and mobile applications to integrate a service fee per listing for their subscriber to feature a product or products they have for sale on “Swipe Shoppe”. Deals for “Swipe Shoppe” hardware and business software would have to configured to this type of format in order to insure all products new and preowned are represented on the “Swipe Shoppe” mobile application and website. With the use of “Swipe Shoppe” business software, and hardware your business or corporation will have a higher probability of increased product volume per quarter due to increased product visibility on the web with people subscribing to and searching for the next product they are going to buy. “Swipe Shoppe” will operate on a mix of cloud and server support systems that has not been determined yet, in order to make the first social shopping network its' kind. There will also be a messenger application to connect to stores and businesses to ask a question about a product or general sale information.

1. The “Swipe Shoppe” mobile application and website software, when combined with the “Swipe Shoppe” business software and hardware will connect buyers and sellers on with an easy to use search platform.

2. “Swipe Shoppe” subscribers will be able to “pre-shop” or browse desired products and be alerted of product availability and be exposed to similar or relatable products in the moving advertisement space.

3. “Swipe Shoppe” users can shop around or browse for products based on search history and shopper profile connections to their favorite websites and stores to shop from in the “My Swipe Shoppe” section. When it comes to physical store bought data (See detailed description for workings)

4-7. (canceled)
